(19) United States
(12) Patent Application Publication
(10) Pub. No.: US 2014/0349210 A1
(43) Pub. Date: Nov. 27, 2014

(54) FUEL CELL STACK

(71) Applicant: HONDA MOTOR CO., LTD, MINATO-KU, TOKYO (JP)

(72) Inventors: Tsuyoshi Kobayashi, Utsunomiya-shi (JP); Yusuke Nara, Utsunomiya-shi (JP)

(21) Appl. No.: 14/367,012

(22) PCT Filed: Dec. 10, 2012
(86) PCT No.: PCT/JP2012/081909

§ 371 Date: Jun. 19, 2014

(30) Foreign Application Priority Data
Dec. 21, 2011 (JP) 2011-280134

(51) Int. Cl. H01M 8/24

(52) U.S. Cl. CPC H01M 8/248; H01M 8/2485
USPC 429/470

(57) ABSTRACT

An objective of the present invention is to allow desirably installing a fuel cell stack in an installation site with a simple and compact configuration. The fuel cell stack comprises an end plate. A pair of mount parts are integrally disposed on the end plate protruding downward on both sides of the lower end part thereof by a depression part being disposed on the lower end part of the end plate. The mount parts are anchored in the installation site for installing the fuel cell stack. Some screws are positioned in the mount parts to anchor to the end plate manifold members which link to a fuel gas supply connector hole and an oxidant gas exhaust connector hole of the fuel cell stack.

### TECHNICAL FIELD

The present invention relates to a fuel cell stack including a plurality of unit cells stacked together in a horizontal direction. Each of the unit cells is formed by stacking an electrolyte electrode assembly and separators. The electrolyte electrode assembly includes an electrolyte and electrodes provided respectively on both sides of the electrolyte.

### BACKGROUND ART

For example, a solid polymer electrolyte fuel cell employs a polymer ion exchange membrane as an electrolyte membrane, and the polymer electrolyte membrane is interposed between an anode and a cathode to form a membrane electrode assembly (MEA). The membrane electrode assembly and a pair of separators sandwiching the membrane electrode assembly make up a unit cell. In the fuel cell of this type, in use, typically, a predetermined number of the unit cells are stacked together, and terminal plates, insulating plates, and end plates are provided at both ends in the stacking direction to form a fuel cell stack, e.g., mounted in a vehicle.

In some cases, the fuel cell stack of this type adopts so called internal manifold structure where fluid passages are formed in the fuel cell stack for allowing a fuel gas, an oxygen-containing gas, and a coolant to flow in the stacking direction of the unit cells. For this purpose, in the fuel cell stack, manifold members connected to the fluid passages are attached to the end plates.

In this regard, the fuel cell stack adopts various types of mounting structures for fixing the fuel cell stack to an installation position such as a fuel cell vehicle. For example, in a fuel cell stack disclosed in Japanese Patent No. 4165876, as shown in FIG. 11, a stack body 1 formed by stacking a plurality of unit cells is placed in a box-shaped casing 2. The casing 2 includes end plate 3a, 3b.

Manifold piping members 4a, 4b are attached to one of the end plates 3a using a plurality of screws (tightening members) 5a. Further, mount brackets 6 are fixed to lower ends of the end plates 3a, 3b using screws 5b, respectively. Each of the mount brackets 6 is fixed to an installation position (e.g., vehicle body of an automobile) using a plurality of screws 5c.

### SUMMARY OF INVENTION

In the fuel cell stack, the mount brackets 6 are fixed to the end plate 3a, 3b, respectively, only using the screws 5b. Therefore, the mount brackets 6 themselves need to have sufficient rigidity. Thus, the mount brackets 6 may have a considerably large size undesirably.

Further, since the mount brackets 6 are fixed to the end plates 3a, 3b using the screws 5b, significant space is required for providing the screws 5b. Consequently, in some cases, the end plates 3a, 3b themselves may have a large size.

The present invention has been made to solve the problem of this type, and an object of the present invention is to provide a fuel cell stack having simple and compact structure which makes it possible to provide the fuel stack at an installation position suitably.

The present invention relates to a fuel cell stack including a stack body formed by stacking a plurality of unit cells together in a horizontal direction and end plates provided at both ends of the stack body in a stacking direction. Each of the unit cells is formed by stacking an electrolyte electrode assembly and separators. The electrolyte electrode assembly includes an electrolyte and electrodes provided respectively on both sides of the electrolyte. A fluid passage is formed in the stack body for allowing at least a fuel gas, an oxygen-containing gas, or a coolant to flow through the fluid passage in the stacking direction.

In the fuel cell stack, a manifold member connected to the fluid passage is fixed to at least one of the end plates using tightening members, and a recess is formed at a lower end of the end plate to provide a pair of mount sections integrally with the lower end. The mount sections protrude downward from both sides of the recess in the lower end. Further, the pair of mount sections are fixed to an installation portion on which the fuel cell stack is installed.

Further, preferably, in the fuel cell stack, at least part of the tightening members are provided in the pair of mount sections.

Further, preferably, in the fuel cell stack, a surface of the end plate for attachment of the manifold member includes the mount section and is flat.

Further, preferably, in the fuel cell stack, a plurality of the recesses are formed at a lower end of the end plate.

Further, preferably, in the fuel cell stack, in the end plate, a bottom of the mount section is fixed by use of a screw.

In the present invention, since the pair of mount sections are provided integrally with the lower end of the end plate, and protrude downward from both sides in the lower end of the end plate, the structure of the mount sections is simplified, and the number of components is reduced suitably. Thus, with the simple and compact structure, it becomes possible to install the fuel cell stack at the installation portion suitably.

### BRIEF DESCRIPTION OF DRAWINGS

FIG. 1 is a perspective view schematically showing a fuel cell stack according to a first embodiment of the present invention;

FIG. 2 is an exploded perspective view showing main components of a unit cell of the fuel cell stack;

FIG. 3 is a front view showing the fuel cell stack;

FIG. 4 is a perspective view schematically showing a fuel cell stack according to a second embodiment of the present invention;

FIG. 5 is an exploded perspective view showing main components of a unit cell of the fuel cell stack;

FIG. 6 is a front view of the fuel cell stack as viewed from one of end plates of the fuel cell stack;

FIG. 7 is a front view of the fuel cell stack as viewed from the other of the end plates of the fuel cell stack;

FIG. 8 is a perspective view schematically showing a fuel cell stack according to a third embodiment of the present invention;

FIG. 9 is a front view of the fuel cell stack as viewed from one of end plates of the fuel cell stack;

FIG. 10 is a front view of the fuel cell stack as viewed from the other of the end plates of the fuel cell stack; and

FIG. 11 is a perspective view showing a fuel cell stack disclosed in Japanese Patent No. 4165876.

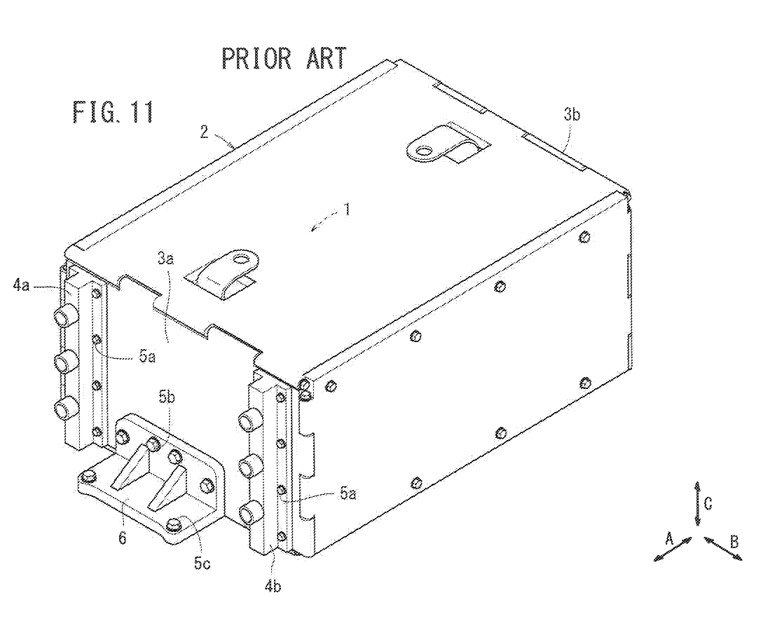

### DESCRIPTION OF EMBODIMENTS

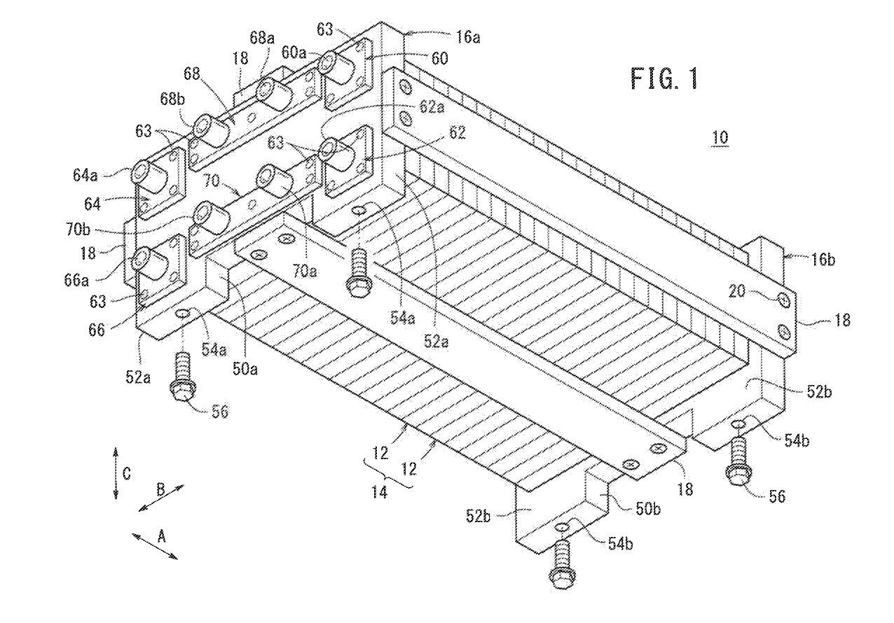

As shown in FIG. 1, a fuel cell stack 10 according to a first embodiment of the present invention includes unit cells 12, and a plurality of the unit cells 12 are stacked together in an upright posture in a horizontal direction indicated by an arrow A to form a stack body 14. At both ends of the stack body 14 in the stacking direction, end plates 16a, 16b are provided. The end plates 16a, 16b are fixed to both ends of a plurality of coupling bars 18 using screws 20 to apply a tightening load to the stack body 14 in the stacking direction.

Instead of the coupling bars 18, tie-rods may be used. Alternatively, the stack body 14 may be placed in a box. Though not shown, terminal plates and insulating plates are provided between the stack body 14 and the end plates 16a, 16b.

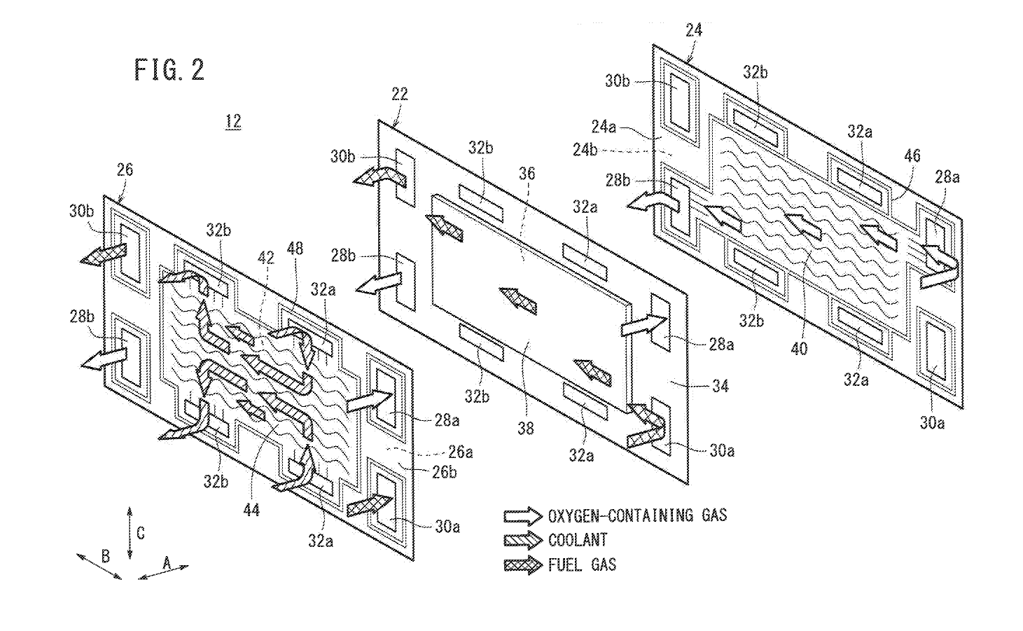

As shown in FIG. 2, each of the unit cells 12 includes a membrane electrode assembly 22 and a first metal separator 24 and a second metal separator 26 sandwiching the membrane electrode assembly 22.

The first metal separator 24 and the second metal separator 26 are made of, e.g., metal plates such as steel plates, stainless steel plates, aluminum plates, plated steel sheets, or metal plates having anti-corrosive surfaces by surface treatment. The first metal separator 24 and the second metal separator 26 have rectangular planar surfaces, and are formed by corrugating metal thin plates by press forming to have a corrugated shape in cross section and a wavy shape on the surface. Instead of the first metal separator 24 and the second metal separator 26, for example, carbon separators may be used.

Each of the first metal separator 24 and the second metal separator 26 has a laterally elongated rectangular shape including long sides orientated in the horizontal direction indicated by an arrow B and short sides oriented in the gravity direction indicated by an arrow C (The first metal separator 24 and the second metal separator 26 are stacked in the horizontal direction.). Alternatively, the short sides of the first metal separator 24 and the second metal separator 26 may be oriented in the horizontal direction and the long sides of the first metal separator 24 and the second metal separator 26 may be oriented in the gravity direction.

At one end of the unit cell 12 in the long-side direction indicated by the arrow B, an oxygen-containing gas supply passage 28a for supplying an oxygen-containing gas and a fuel gas supply passage 30a for supplying a fuel gas, e.g., a hydrogen-containing gas, are provided. The oxygen-containing gas supply passage 28a and the fuel gas supply passage 30a extend through the unit cell 12 in the direction indicated by the arrow A.

At the other end of the unit cell 12 in the long-side direction, a fuel gas discharge passage 30b for discharging the fuel gas and an oxygen-containing gas discharge passage 28b for discharging the oxygen-containing gas are provided. The fuel gas discharge passage 30b and the oxygen-containing gas discharge passage 28b extend through the unit cell 12 in the direction indicated by the arrow A.

At both ends of the unit cell 12 in the short-side direction indicated by the arrow C, two coolant supply passages 32a for supplying a coolant are provided on one side (adjacent to the reactant gas inlet). On the other side (adjacent to the reactant gas outlet) at both ends of the unit cell 12 in the short-side direction, two coolant discharge passages 32b for discharging a coolant are provided. The coolant supply passages 32a and the coolant discharge passages 32b extend through the unit cell 12 in the direction indicated by the arrow A.

The membrane electrode assembly 22 includes a solid polymer electrolyte membrane 34, and a cathode 36 and an anode 38 sandwiching the solid polymer electrolyte membrane 34. The solid polymer electrolyte membrane 34 is formed by impregnating a thin membrane of perfluorosulfonic acid with water, for example.

Each of the cathode 36 and the anode 38 has a gas diffusion layer (not shown) such as a carbon paper, and an electrode catalyst layer (not shown) of platinum alloy supported on porous carbon particles. The carbon particles are deposited uniformly on the surface of the gas diffusion layer. The electrode catalyst layer of the cathode 36 and the electrode catalyst layer of the anode 38 are formed on both surfaces of the solid polymer electrolyte membrane 34, respectively.

The first metal separator 24 has an oxygen-containing gas flow field 40 on its surface 24a facing the membrane electrode assembly 22. The oxygen-containing gas flow field 40 is connected to the oxygen-containing gas supply passage 28a and the oxygen-containing gas discharge passage 28b. The oxygen-containing gas flow field 40 includes a plurality of flow grooves in a wavy pattern extending in the direction indicated by the arrow B.

The second metal separator 26 has a fuel gas flow field 42 on its surface 26a facing the membrane electrode assembly 22. The fuel gas flow field 42 is connected to the fuel gas supply passage 30a and the fuel gas discharge passage 30b. The fuel gas flow field 42 includes a plurality of flow grooves in a wavy pattern extending in the direction indicated by the arrow B.

A coolant flow field 44 is formed between a surface 26b of the second metal separator 26 and a surface 24b of the first metal separator 24. The coolant flow field 44 is connected to the coolant supply passages 32a, 32a and the coolant discharge passages 32b, 32b. In the coolant flow field 44, the coolant flows over the electrode area of the membrane electrode assembly 22.

A first seal member 46 is formed integrally with the surfaces 24a, 24b of the first metal separator 24 around the outer circumferential end of the first metal separator 24. A second seal member 48 is formed integrally with the surfaces 26a, 26b of the second metal separator 26 around the outer circumferential end of the second metal separator 26. Each of the first seal member 46 and the second seal member 48 is made of seal material, cushion material, or packing material such as an EPDM, an NBR, a fluoro rubber, a silicone rubber, a fluorosilicone rubber, a butyl rubber, a natural rubber, a styrene rubber, a chloroprene rubber, an acrylic rubber, etc.

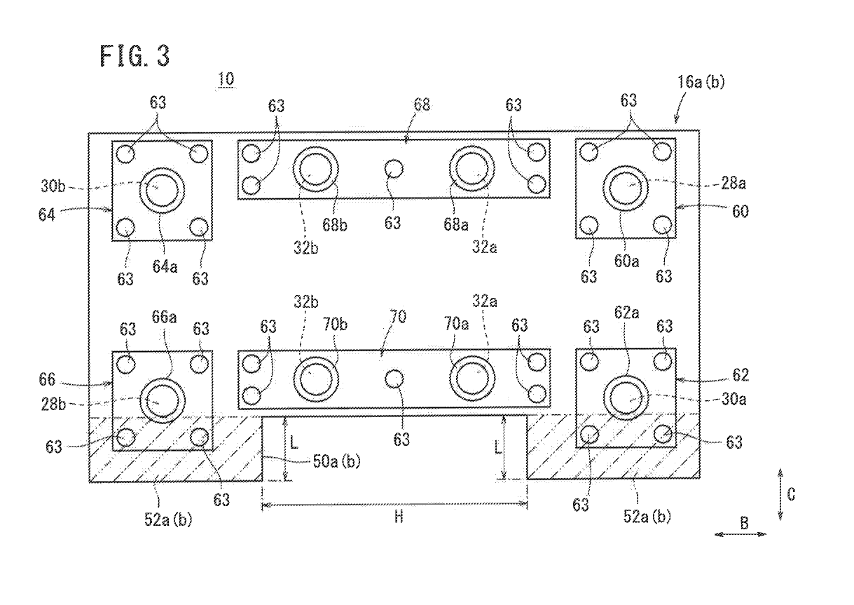

As shown in FIGS. 1 and 3, recesses 50a, 50b are formed at central portions in lower ends of the end plates 16a, 16b, respectively, so that a pair of mount sections 52a and a pair of mount sections 52b are formed integrally with the end plates 16a, 16b. The mount sections 52a, 52b protrude downward from both sides in the lower ends of the end plates 16a, 16b. Each of the recesses 50a, 50b is a rectangular opening having an area size of a distance L spaced upward from a lower end position of the end plate 16a, 16b and a distance H in the horizontal direction. As described later, the distance L and the distance H are determined depending on the positions where manifold members are attached.

A screw hole 54a, 54b is formed at each of the bottoms of the mount sections 52a, 52b. A plurality of screw holes 54a and a plurality of screw holes 54b may be formed. Screws 56 are screwed into the screw holes 54a, 54b to fix the mount sections 52a, 52b to an installation position, e.g., a vehicle body frame (not shown) of a fuel cell electric vehicle directly or through other members such as a cover member (not shown) or a bracket. The entire surfaces of the end plates 16a, 16b including the mount sections 52a, 52b are flat.

Manifold members 60, 62 are attached to the end plate 16a at upper and lower positions, at one end in the long-side direction, using a plurality of screws (tightening members) 63, respectively. The manifold member 60 includes a pipe 60a connected to the oxygen-containing gas supply passage 28a, and the manifold member 62 includes a pipe 62a connected to the fuel gas supply passage 30a. The tightening members are not limited to the screws 63. Commonly used mechanical clamp mechanisms may be used.

Manifold members 64, 66 are attached to the end plate 16a at upper and lower positions, at the other end in the long-side direction, using a plurality of screws 63, respectively. The manifold member 64 includes a pipe 64a connected to the fuel gas discharge passage 30b, and the manifold member 66 includes a pipe 66a connected to the oxygen-containing gas discharge passage 28b.

A manifold member 68 is attached to the end plate 16a at an upper end in the short-side direction using a plurality of screws 63, and a manifold member 70 is attached to the end plate 16a at a lower end in the short-side direction using a plurality of screws 63. The manifold member 68 includes a pipe 68a connected to the coolant supply passage 32a and a pipe 68b connected to the coolant discharge passage 32b. The manifold member 70 includes a pipe 70a connected to the coolant supply passage 32a and a pipe 70b connected to the coolant discharge passage 32b.

In the manifold members 62, 66, the lower screws 63 serving as tightening points are disposed within the mount sections 52a, 52b. The lower screws 63 are positioned within an area of the recess 50a in the horizontal direction, i.e., within an area of the height L of the recess 50a (in the direction indicated by the arrow C). The distance L and the distance H of the recess 50a are determined to have maximum values by which, in particular, the manifold members 62, 66, and 70 can be fixed efficiently to the end plate 16a by the screws 63.

Operation of the fuel cell stack 10 having the above structure will be described below.

Firstly, as shown in FIGS. 1 and 3, an oxygen-containing gas is supplied from the pipe 60a to the oxygen-containing gas supply passage 28a, and a fuel gas such as a hydrogen containing gas is supplied from the pipe 62a to the fuel gas supply passage 30a. Further, a coolant such as pure water, ethylene glycol, oil, or the like is supplied from the pipes 68a, 70a to the pair of the coolant supply passages 32a.

Thus, as shown in FIG. 2, the oxygen-containing gas flows from the oxygen-containing gas supply passage 28a into the oxygen-containing gas flow field 40 of the first metal separator 24. The oxygen-containing gas flows along the oxygen-containing gas flow field 40 in the direction indicated by the arrow B, and the oxygen-containing gas is supplied to the cathode 36 of the membrane electrode assembly 22.

The fuel gas is supplied from the fuel gas supply passage 30a to the fuel gas flow field 42 of the second metal separator 26. The fuel gas moves along the fuel gas flow field 42 in the direction indicated by the arrow B, and then, the fuel gas is supplied to the anode 38 of the membrane electrode assembly 22.

Thus, in the membrane electrode assembly 22, the oxygen-containing gas supplied to the cathode 36, and the fuel gas supplied to the anode 38 are consumed in electrochemical reactions at catalyst layers of the cathode 36 and the anode 38 for generating electricity.

Then, the oxygen-containing gas consumed at the cathode 36 of the membrane electrode assembly 22 flows along the oxygen-containing gas discharge passage 28b in the direction indicated by the arrow A, and the oxygen-containing gas is discharged from the pipe 66a (see FIG. 3). In the meanwhile, the fuel gas consumed at the anode 38 of the membrane electrode assembly 22 flows along the fuel gas discharge passage 30b in the direction indicated by the arrow A, and the fuel gas is discharged from the pipe 64a (see FIG. 3).

Further, as shown in FIG. 2, the coolant supplied to the pair of coolant supply passages 32a flows into the coolant flow field 44 between the first metal separator 24 and the second metal separator 26. After the coolant temporarily flows inward in the direction indicated by the arrow C, the coolant moves in the direction indicated by the arrow B to cool the membrane electrode assembly 22. After the coolant moves outward in the direction indicated by the arrow C, the coolant flows through the pair of coolant discharge passages 32b, and then is discharged from the pipes 68b, 70b.

In the first embodiment, as shown in FIGS. 1 and 3, the recesses 50a, 50b are formed at central portions in lower ends of the end plates 16a, 16b, respectively, whereby the pairs of mount sections 52a, 52b are provided integrally with the end plates 16a, 16b, respectively. The mount sections 52a, 52b protrude downward from both sides in the lower ends of the end plates 16a, 16b. In the structure, in comparison with the case where members separate from the end plates 16a, 16b are used as mounting structure, the structure of the mount sections 52a, 52b is simplified significantly, and the number of components is reduced suitably and economically.

Further, as shown in FIG. 3, the screws (tightening members) 63 for fixing, to the end plate 16a, the manifold members 62, 66 connected to the fuel gas supply passage 30a and the oxygen-containing gas discharge passage 28b of the fuel cell stack 10 are disposed within the mount section 52a. Therefore, the size of the end plates 16a, 16b in the height direction indicated by the arrow C is reduced as much as possible. With the simple and compact structure, it becomes possible to provide the fuel cell stack 10 at the installation position suitably and advantageously.

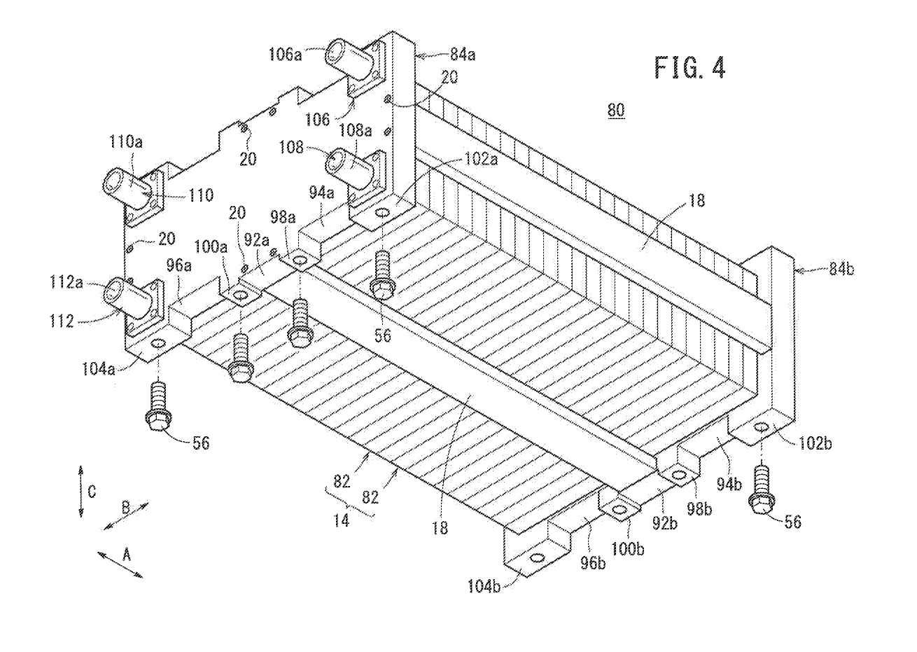

FIG. 4 is a perspective view schematically showing a fuel cell stack 80 according to a second embodiment of the present invention. The constituent elements that are identical to those of the fuel cell stack 10 according to the first embodiment are labeled with the same reference numerals, and description thereof will be omitted.

The fuel cell stack 80 includes a stack body 14 formed by stacking a plurality of unit cells 82 together in an upright posture in a horizontal direction indicated by an arrow A.

At both ends of the stack body 14 in the stacking direction, end plates 84a, 84b are provided. The end plates 84a, 84b are fixed using a plurality of coupling bars 18. Both end surfaces of the coupling bars 18 abut against the inner plate surfaces of the end plates 84a, 84b. Screws 20 are screwed from the outer plate surfaces of the end plates 84a, 84b into the end surfaces of the coupling bars 18 in the stacking direction.

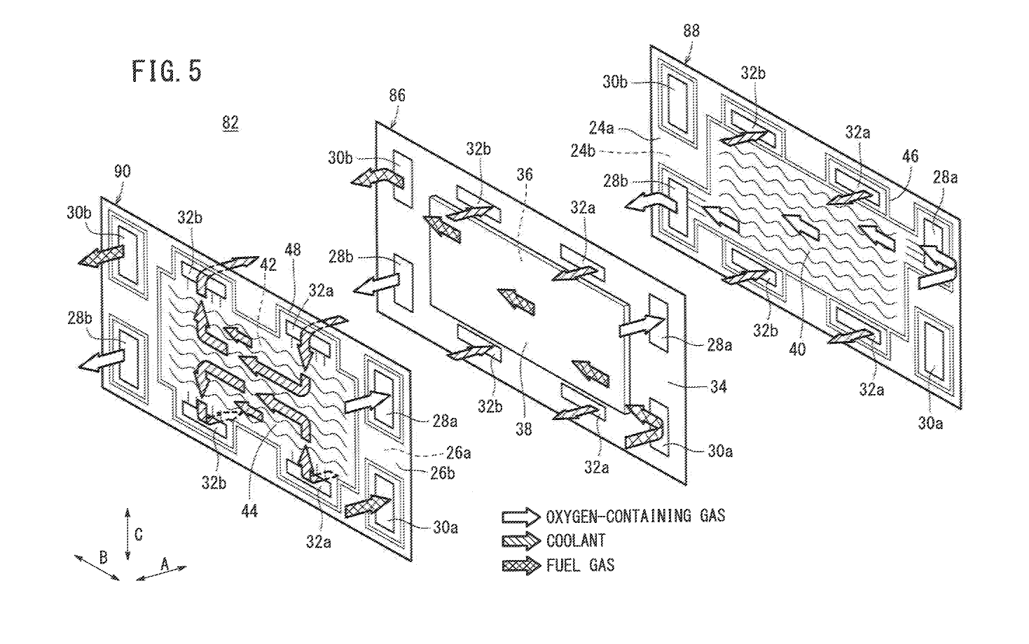

As shown in FIG. 5, the unit cell 82 includes a membrane electrode assembly 86 and a first metal separator 88 and a second metal separator 90 sandwiching the membrane electrode assembly 86. In the unit cell 82, the flow direction of the oxygen-containing gas in the oxygen-containing gas supply passage 28a and the fuel gas in the fuel gas supply passage 30a in the stacking direction is opposite to the flow direction of the coolant in the coolant supply passages 32a in the stacking direction. Likewise, the flow direction of the oxygen-containing gas in the oxygen-containing gas discharge passage 28b and the fuel gas in the fuel gas discharge passage 30b in the stacking direction is opposite to the flow direction of the coolant in the coolant discharge passages 32b in the stacking direction.

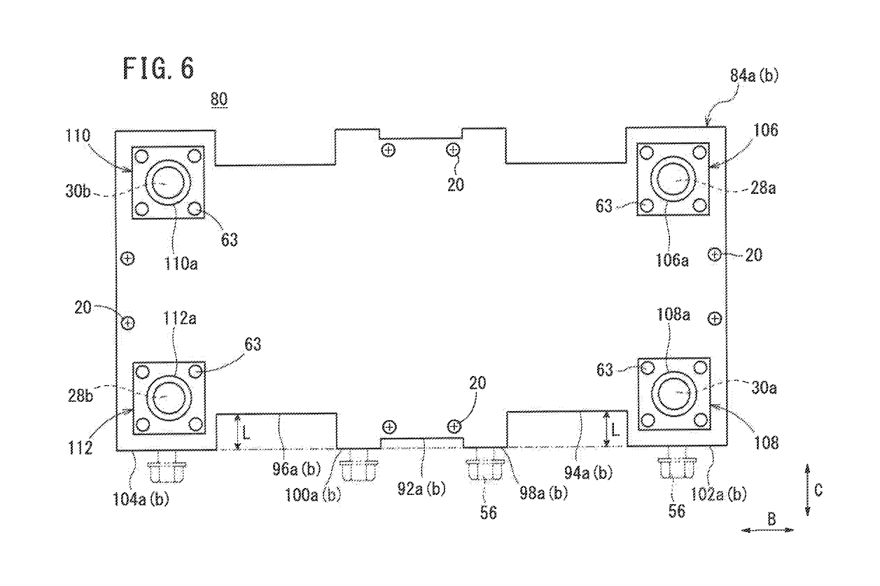

As shown in FIGS. 4 and 6, recesses 92a, 92b are formed at central portions in lower ends of the end plates 84a, 84b. Recesses 94a, 96a are formed on both sides of the recess 92a at a predetermined distance. Recesses 94b, 96b are formed on both sides of the recess 92b at a predetermined distance.

A pair of mount sections 98a, 100a are provided at the lower end of the end plate 84a, between the recesses 92a and 94a, and between the recesses 92a and 96a. A pair of mount sections 102a, 104a are provided outside the recesses 94a and 96a. Likewise, mount sections 98b, 100b, 102b, and 104b are provided on the end plates 84b through recesses 92b, 94b, and 96b.

Manifold members 106, 108 are attached to one end of the end plate 84a in the long-side direction, at upper and lower positions using screws 63. The manifold member 106 includes a pipe 106a connected to the oxygen-containing gas supply passage 28a, and the manifold member 108 includes a pipe 108a connected to the fuel gas supply passage 30a. Manifold members 110, 112 are attached to the other end of the end plate 84a in the long-side direction, at upper and lower positions using screws 63. The manifold member 110 includes a pipe 110a connected to the fuel gas discharge passage 30b, and the manifold member 112 includes a pipe 112a connected to the oxygen-containing gas discharge passage 28b.

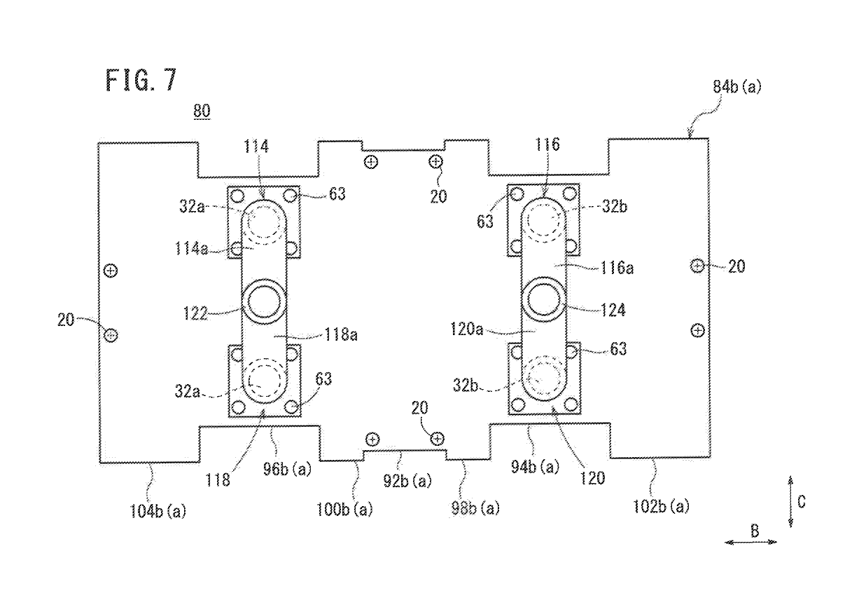

As shown in FIG. 7, manifold members 114, 116 are attached to the end plate 84b, at an upper end in the short-side direction using screws 63, and manifold members 118, 120 are attached to the end plate 84b, at a lower end in the short-side direction of the end plate 84b using screws 63. The manifold members 114, 118 provided at upper and lower positions have respective pipes 114a, 118a connected respectively to the coolant supply passages 32a, and the pipes 114a, 118a are connected to a single pipe 122. The manifold members 116, 120 provided at upper and lower positions have respective pipes 116a, 120a connected respectively to the coolant discharge passages 32b, and the pipes 116a, 120a are connected to a single pipe 124.

In the second embodiment having the above structure, the pair of mount sections 98a, 100a are formed integrally with the lower end of the end plate 84a on both sides of the recess 92a, and the pair of mount sections 102a, 104a are formed integrally with the lower end of the end plate 84a with the recesses 94a, 96a interposed therebetween. Further, the mount sections 98b, 100b are provided integrally with the end plate 84b on both sides of the recess 92b, and the mount sections 102b, 104b are provided integrally with the end plate 84b with the recesses 94b, 96b interposed therebetween. Thus, the same advantages as in the case of the first embodiment are obtained. For example, in comparison with the case where members separate from the end plates 84a, 84b are used as mounting structure, the structure of the mount sections is simplified significantly.

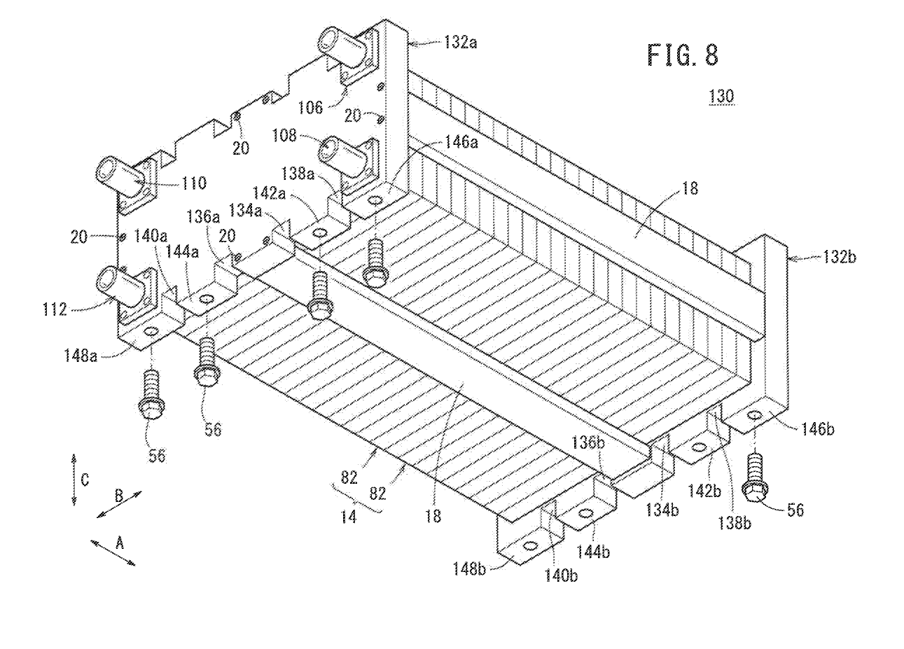

FIG. 8 is a perspective view schematically showing a fuel cell stack 130 according to a third embodiment of the present invention. The constituent elements of the fuel cell stack 130 according to the third embodiment of the present invention that are identical to those of the fuel cell stack 80 according to the second embodiment are labeled with the same reference numerals, and description thereof will be omitted.

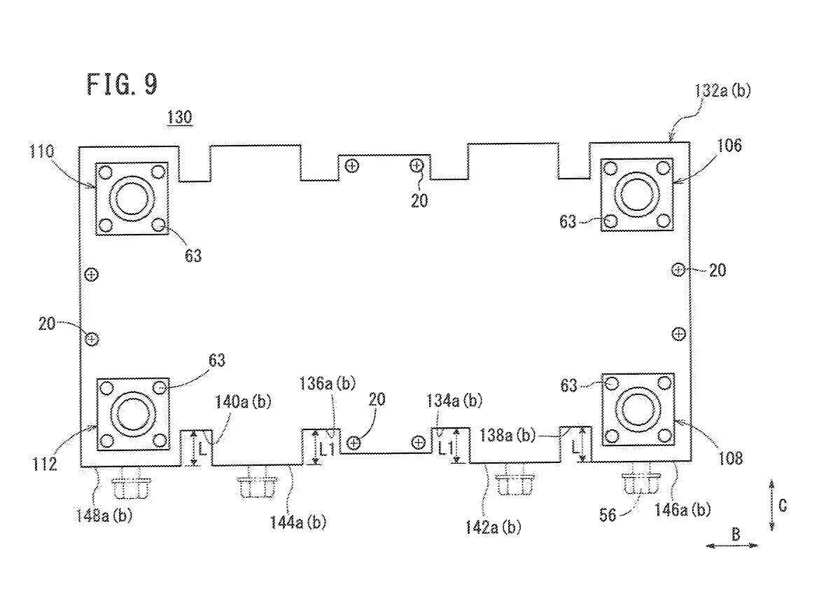

The fuel cell stack 130 includes end plates 132a, 132b provided at both ends of the stack body 14 in the stacking direction. As shown in FIG. 9, the end plate 132a has recesses 134a, 136a on both sides of a lower central portion thereof, and recesses 138a, 140a, which are provided at positions spaced outward from the recesses 134a, 136a by a predetermined interval, respectively. A mount section 142a is formed between the recesses 134a, 138a, and a mount section 144a is formed between the recesses 136a, 140a.

Mount sections 146a, 148a are formed outside the recesses 138a, 140a. The recesses 134a, 136a have a depth spaced upward from a lower end position of the end plate 132a by a distance L1.

Likewise, the end plate 132b has recesses 134b, 136b, 138b, and 140b whereby mount sections 142b, 144b, 146b, and 148b are formed. Manifold members 106, 108, 110, and 112 are fixed to the end plate 132a using screws 63.

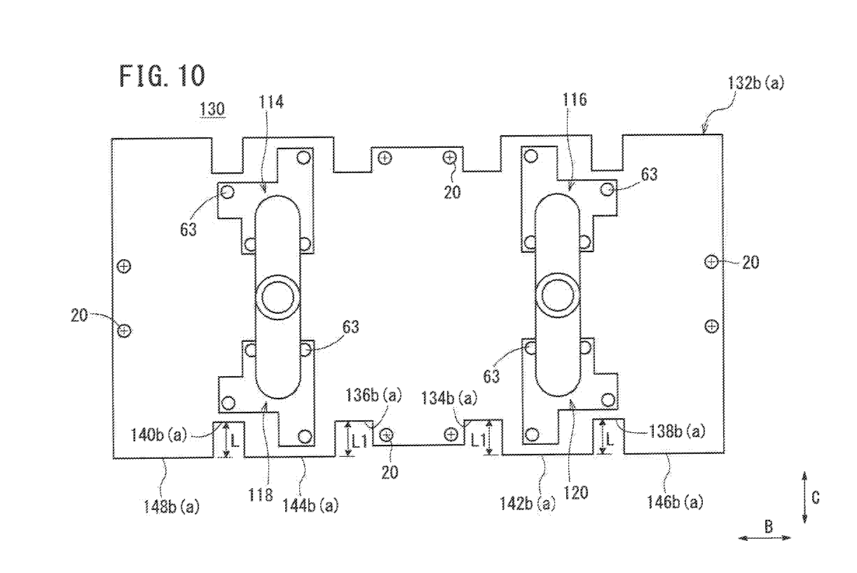

As shown in FIG. 10, the manifold members 114, 116 are fixed to the end plate 132b using screws 63. The recesses 134b, 136b have a depth spaced upward from a lower end position of the end plate 132b by a distance L1. Screws 63 at lower positions for fixing the manifold members 118, 120 are disposed within the distance L1.

The distance L1 and the distance L may be the same, or different depending on the shapes of attachment members or the like. In the third embodiment having the structure as described above, the same advantages as in the cases of the first and second embodiments are obtained.

1. A fuel cell stack including a stack body formed by stacking a plurality of unit cells together in a horizontal direction and end plates provided at both ends of the stack body in a stacking direction, the unit cells each being formed by stacking an electrolyte electrode assembly and separators, the electrolyte electrode assembly including an electrolyte and electrodes provided respectively on both sides of the electrolyte, a fluid passage being formed in the stack body for allowing at least a fuel gas, an oxygen-containing gas, or a coolant to flow through the fluid passage in the stacking direction,
wherein a manifold member connected to the fluid passage is fixed to at least one of the end plates using tightening members; and
a recess is formed at a lower end of the end plate to provide a pair of mount sections integrally with the lower end, the mount sections protruding downward of the fluid passage from both sides of the recess in the lower end.

2. The fuel cell stack according to claim 1, wherein at least part of the tightening members are provided in the pair of mount sections.

3. The fuel cell stack according to claim 1, wherein a surface of the end plate for attachment of the manifold member includes the mount section and is flat.

4. The fuel cell stack according to claim 1, wherein a plurality of the recesses are formed at a lower end of the end plate.

5. The fuel cell stack according to claim 1, wherein in the end plate, a bottom of the mount section is fixed by use of a screw.
